(19) United States
(12) Patent Application Publication
(10) Pub. No.: US 2015/0221250 A1
(43) Pub. Date: Aug. 6, 2015

(54) LIGHT RECEIVING DEVICE AND IMAGE DISPLAY DEVICE

(71) Applicant: Panasonic Corporation, Osaka (JP)

(72) Inventors: Naoto TADA, Osaka (JP); Suguru NAKAO, Hyogo (JP); Yohei KODERA, Osaka (JP)

(21) Appl. No.: 14/493,558

(22) Filed: Sep. 23, 2014

(30) Foreign Application Priority Data
Jan. 31, 2014 (JP) 2014-016561
Feb. 26, 2014 (JP) 2014-035003

(51) Int. Cl. G09G 3/20; G01J 1/04; G01J 1/42

(52) U.S. Cl. CPC G09G 3/2092; G01J 1/4204; G01J 1/0407; G09G 2320/0626; G09G 2360/144

(57) ABSTRACT

The light receiving device includes the illuminance sensor which detects illuminance of external light, and a light guide portion which guides the external light into the sensor. The light guide portion has a light incident surface and a light exit surface. At least one of the light incident surface and the light exit surface has an inclined surface, the external light introduced into the light guide portion through the light incident surface contains external light incident on the light incident surface from a predetermined angle direction and external light incident on the light incident surface from a horizontal direction, and an angle of the inclined surface is set such that a difference between light reception sensitivity of the sensor to the external light incident from the predetermined angle direction and light reception sensitivity of the sensor to the external light incident from the horizontal direction falls within a predetermined range.

### BACKGROUND OF THE INVENTION

1. Field of the Invention

This disclosure relates to a light receiving device and an image display device where brightness of a display panel can be adjusted corresponding to brightness of an area around the light receiving device and the image display device in an in-use environment.

2. Description of the Related Art

Image display devices such as television receiver sets or monitors for providing various public advertisements which use a liquid crystal panel or the like as a display device have been used in various and versatile installation environments along with the popularization of such image display devices in ordinary households and many commercial facilities.

For example, a liquid crystal television receiver set for a public advertisement information system in a traffic medium described in PTL 1 has a function of automatically optimizing brightness using an automatic brightness sensor which can detect brightness in daytime as well as at night.

### CITATION LIST

### Patent Literature

PTL 1: Unexamined Japanese Patent Publication No. 2000-200077

### SUMMARY OF THE INVENTION

This disclosure provides a light receiving device including an illuminance sensor having light reception sensitivity which conforms to standards on display prescribed in “ENERGY STAR (registered trademark) program” which is the institution concerned with energy saving of office equipment, and an image display device having such an illuminance sensor.

The light receiving device according to this disclosure includes the illuminance sensor which detects illuminance of external light, and a light guide portion which guides the external light into the illuminance sensor. The light guide portion has a light incident surface through which the external light is introduced into the light guide portion, and a light exit surface from which the external light introduced into the light guide portion through the light incident surface exits to the illuminance sensor. At least one of the light incident surface and the light exit surface has an inclined surface, the external light introduced into the light guide portion through the light incident surface contains external light incident on the light incident surface from a predetermined angle direction and external light incident on the light incident surface from a horizontal direction, and an angle of the inclined surface is set such that a difference between light reception sensitivity of the illuminance sensor to the external light incident from the predetermined angle direction and light reception sensitivity of the illuminance sensor to the external light incident from the horizontal direction falls within a predetermined range.

The image display device according to this disclosure includes the above-mentioned light receiving device and a display panel having a screen on which an image is displayed. The light receiving device adjusts brightness of the display panel.

As external light incident on the light receiving device according to this disclosure, there are external light incident at a predetermined angle with respect to a horizontal direction such as illumination light, and external light incident from an approximately horizontal direction as in the case of test light from a light source for testing products with automatic brightness control (ABC) established by default on “ENERGY STAR (registered trademark) Program” Requirements for Displays. The light receiving device according to this disclosure can automatically adjust brightness of the display panel with respect to both the external light.

### BRIEF DESCRIPTION OF DRAWINGS

FIG. 1A is a perspective view showing an image display device including a light receiving device of a first exemplary embodiment;

FIG. 1B is an enlarged view showing a portion surrounded by a dotted line in FIG. 1A in an enlarged manner;

FIG. 2 shows an arrangement of a light source for testing products with ABC established by default on INTERNATIONAL ENERGY STAR Program Requirements for Displays;

FIG. 3 shows the arrangement of the light source in an in-use environment;

FIG. 4 is a cross-sectional view of the light receiving device of the first exemplary embodiment taken along line 4-4 in FIG. 1B;

FIG. 5 is a schematic view showing propagation of test light and illumination light in the light receiving device shown in FIG. 4;

FIG. 6 is a graph showing light reception sensitivity of a light receiving portion of the light receiving device of the first exemplary embodiment;

FIG. 7 is a cross-sectional view of another light receiving device of the first exemplary embodiment;

FIG. 8A is a cross-sectional view of still another light receiving device of the first exemplary embodiment;

FIG. 8B is a cross-sectional view of yet another light receiving device of the first exemplary embodiment;

FIG. 8C is a cross-sectional view of yet another light receiving device of the first exemplary embodiment;

FIG. 8D is a cross-sectional view of yet another light receiving device of the first exemplary embodiment;

FIG. 9A is a perspective view showing an image display device including a light receiving device of a second exemplary embodiment;

FIG. 9B is an enlarged view showing a portion surrounded by a dotted line in FIG. 9A in an enlarged manner;

FIG. 10 is a cross-sectional view of the light receiving device of the second exemplary embodiment taken along line 10-10 in FIG. 9B;

FIG. 11 is a schematic view showing propagation of test light and illumination light in the light receiving device shown in FIG. 10;

FIG. 12 is a graph showing light reception sensitivity of a light receiving portion of the light receiving device of the second exemplary embodiment; and

FIG. 13 is a schematic view showing propagation of test light and illumination light in a light receiving device different from the light receiving device shown in FIG. 10.

### DETAILED DESCRIPTION OF THE PREFERRED EMBODIMENTS

Hereinafter, exemplary embodiments are described in detail with reference to drawings in a proper manner. Here, any detailed description which is more than necessary may be omitted. For example, the detailed description of a well-known matter or the repeated description with respect to the substantially same configuration may be omitted. Such description is omitted in order to prevent the description made hereinafter from becoming unnecessarily redundant thus facilitating those who are skilled in the art to understand this disclosure.

Here, the attached drawings and the description made hereinafter are provided for enabling those who are skilled in the art to sufficiently understand this disclosure, and they are not intended to limit the present disclosure called for in Claims.

### First Exemplary Embodiment

### 1-1. Configuration

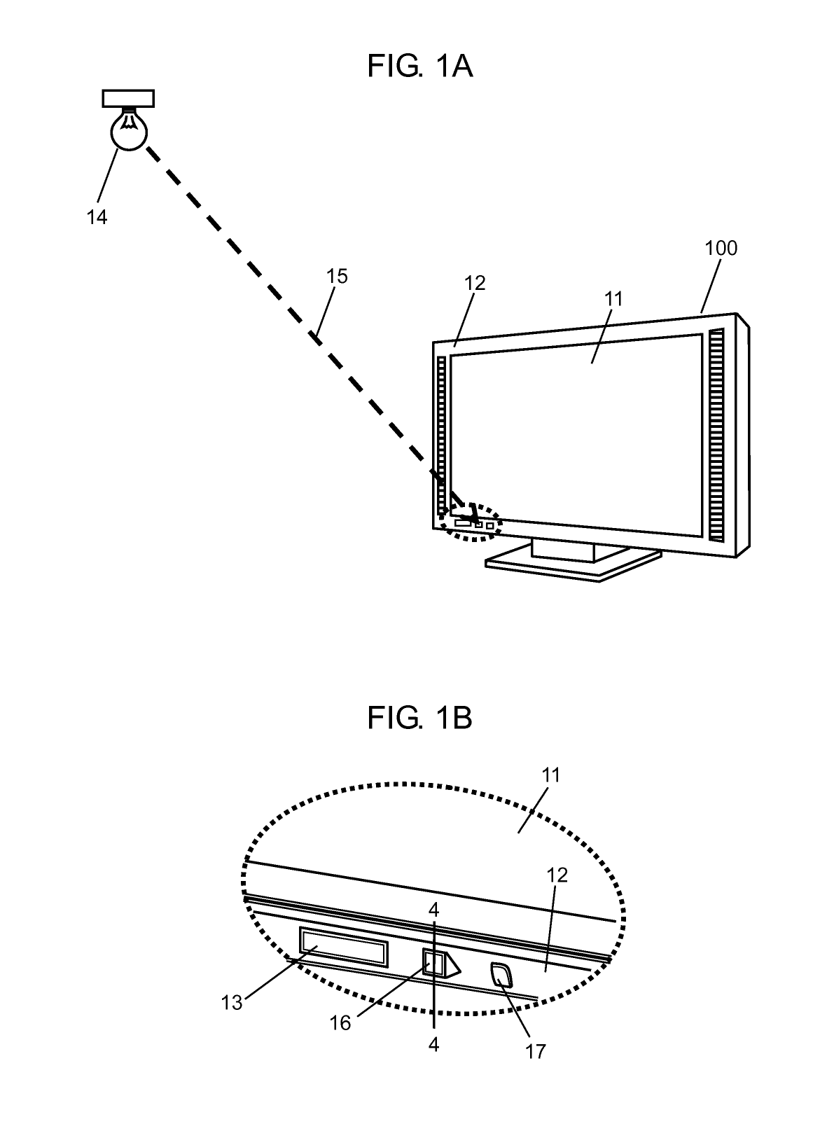

FIG. 1A is a perspective view showing image display device 100 including light receiving device 16 of a first exemplary embodiment, and FIG. 1B is an enlarged view showing a portion of the image display device surrounded by a dotted line in FIG. 1A in an enlarged manner.

In FIG. 1A and FIG. 1B, flat-plate-shaped image display device 100 includes narrow picture-frame-shaped bezel 12 mounted on the periphery of display panel 11. Three opening portions are formed on a lower side portion of bezel 12, and remote control receiver 13, light receiving device 16 and power source lamp 17 are disposed in the opening portions respectively. Remote control receiver 13 receives remote control signals such as infrared signals from a remote controller (not shown) which is operated by a user. Light receiving device 16 takes in illumination light 15 from illumination light source 14 disposed on a ceiling of a room where image display device 100 is disposed, and automatically adjusts brightness of display panel 11 corresponding to illumination light 15. Power source lamp 17 displays a state of a power source of image display device 100.

Firstly, the task of a light receiving device in an image display device is described. “ENERGY STAR (registered trademark) Program” Requirements for Displays which is the institution on energy saving of office equipment was revised to a version 6.0 in 2012. One of revised contents is that lighting conditions for testing products with automatic brightness control (ABC) established by default are stipulated in Test Method for Determining Displays Energy Use prescribed in Product Specification For Displays.

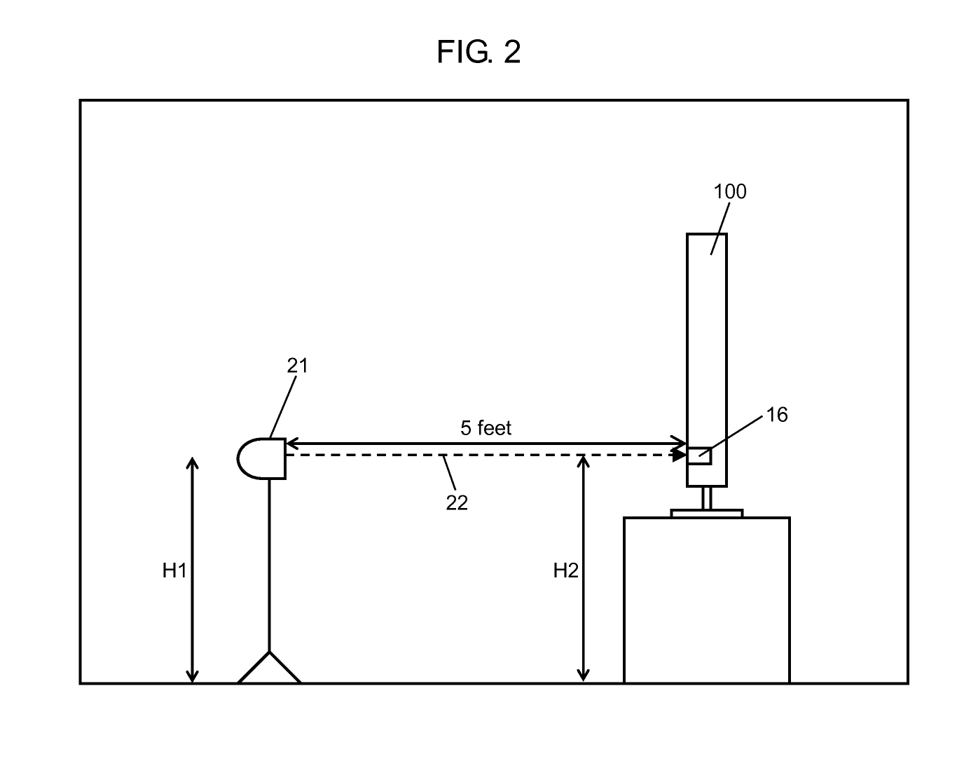

FIG. 2 shows an arrangement of a light source for testing products with ABC established by default on “ENERGY STAR (registered trademark) Program” Requirements for Displays. In FIG. 2, test light source 21 is disposed at a position five feet away from light receiving device 16 of image display device 100. A horizontal reference surface of test light source 21, for example, height H1 from a floor is equal to a horizontal reference surface of light receiving device 16 of image display device 100, for example, height H2 from the floor. Test light source 21 illuminates light receiving device 16 of image display device 100 with test light 22 at predetermined illuminance. To satisfy “ENERGY STAR (registered trademark) Program” Requirements for Displays, light receiving device 16 is required to automatically adjust brightness of display panel 11 corresponding to test light 22 with the arrangement of test light source 21 shown in FIG. 2.

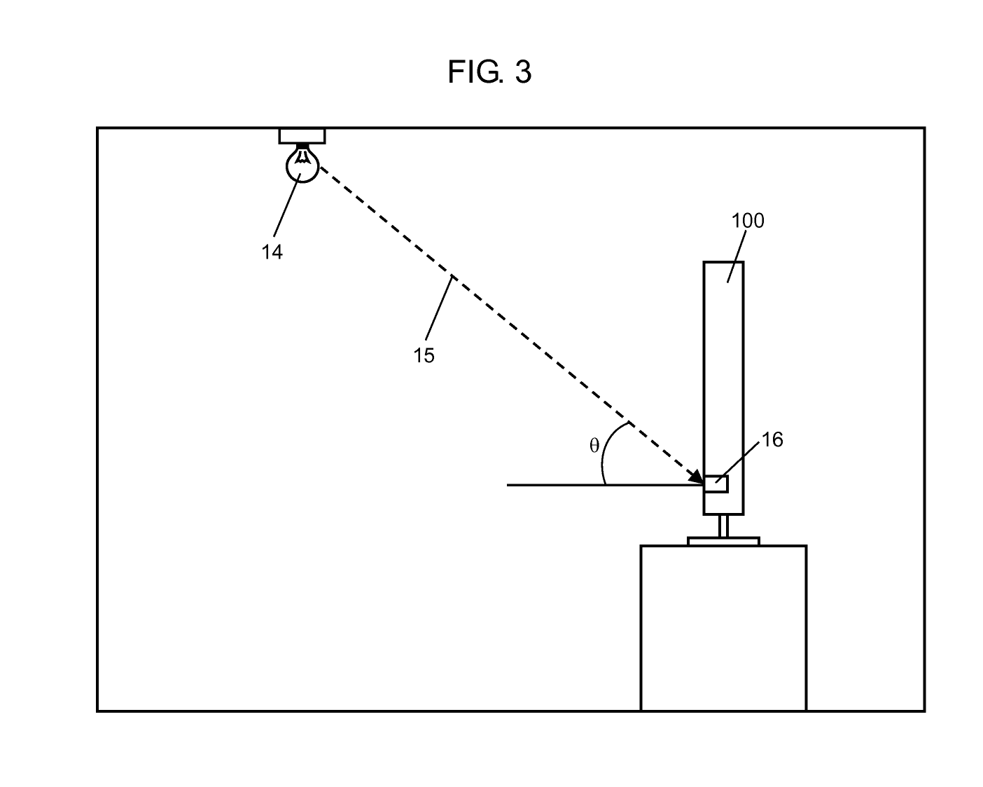

FIG. 3 shows the arrangement of a light source in an in-use environment. In an environment where a user uses the light source, light receiving device 16 is required to automatically adjust brightness of display panel 11 corresponding to illumination light 15 from illumination light source 14 disposed on a ceiling of a room where image display device 100 is disposed.

Here, assume that angle θ of illumination light 15 from a horizontal plane of light receiving device 16 falls within a range from 20° to 70°.

In a state shown in FIG. 2 to a state shown in FIG. 3, light receiving device 16 is required to automatically adjust brightness of display panel 11 also corresponding to illumination light 15 in the in-use environment while automatically adjusting brightness of display panel 11 corresponding to test light 22 so as to satisfy “ENERGY STAR (registered trademark) Program” Requirements for Displays. That is, light receiving device 16 is required to automatically adjust brightness of display panel 11 corresponding to both external light incident on the light receiving device, that is, external light incident on the light receiving device at a predetermined angle with respect to the horizontal direction such as illumination light 15 and external light incident on the light receiving device from the approximately horizontal direction such as test light 22.

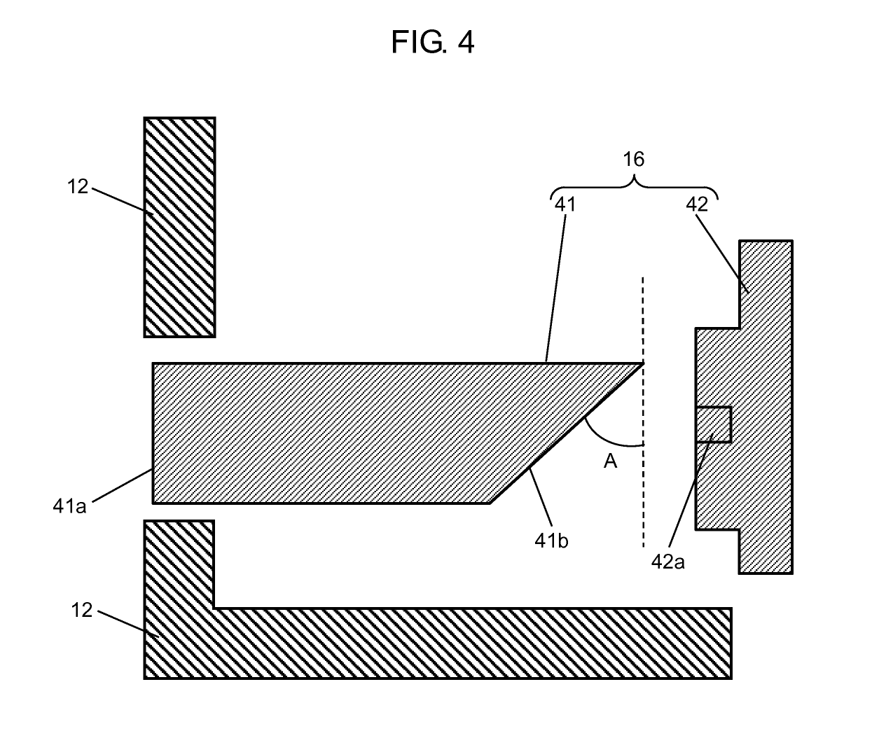

FIG. 4 is a cross-sectional view of light receiving device 16 of this exemplary embodiment taken along line 4-4 in FIG. 1B. Light receiving device 16 includes light guide portion 41 and illuminance sensor 42. Light receiving device 16 is of a direct incident type where illuminance sensor 42 is disposed perpendicular to light guide portion 41.

Light guide portion 41 is formed of a transparent resin member made of polystyrene resin, and has a columnar shape. Light guide portion 41 includes light incident surface 41a which guides illumination light 15 and test light 22, and light exit surface 41b which is formed so as to face light incident surface 41a in an inclined manner with respect to light incident surface 41a, and enables illumination light 15 and test light 22 to exit to illuminance sensor 42 while adjusting an amount of illumination light 15 and an amount of test light 22. Illuminance sensor 42 includes light receiving portion 42a which detects illuminance of illumination light 15 and illuminance of test light 22. Here, light receiving portion 42a has a vertical length of 0.4 mm, and light guide portion 41 has a thickness of 2 mm, a width of 5 mm, and a length of 10 mm.

Angle A of light exit surface 41b with respect to light incident surface 41a is set larger than a total reflection angle intrinsic to a material from which light guide portion 41 is made.

### 1-2. Operation

The operation of light receiving device 16 having the above-mentioned configuration is described hereinafter.

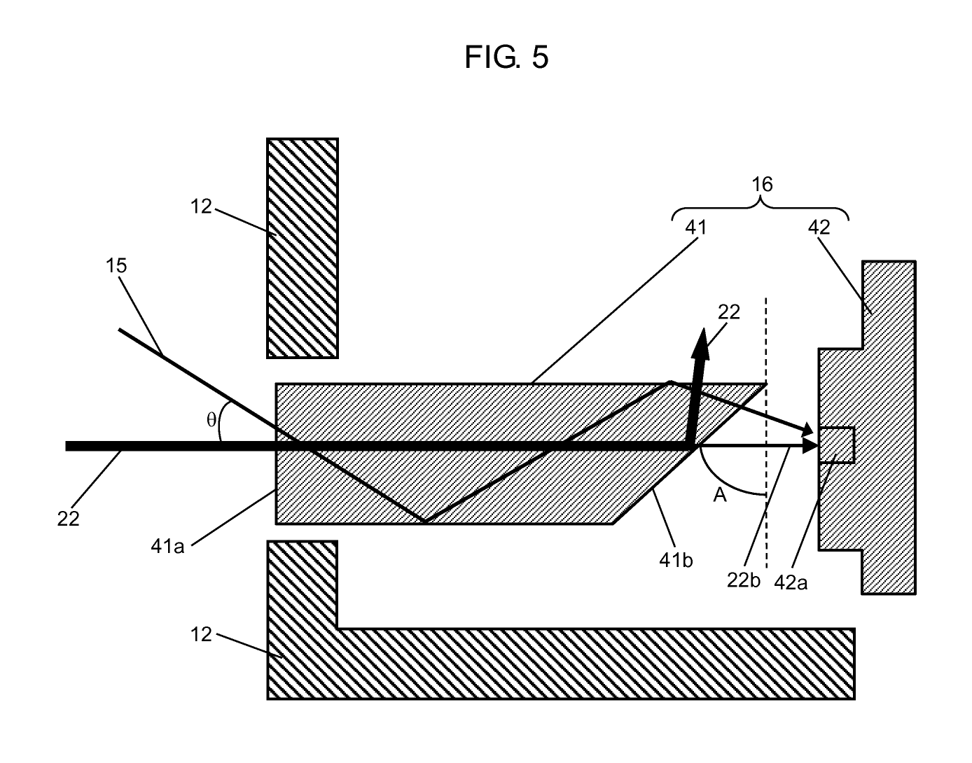

FIG. 5 is a schematic view showing propagation of test light 22 and illumination light 15 in the cross-sectional view of light receiving device 16 shown in FIG. 4 taken along line 4-4 in FIG. 1B.

As shown in FIG. 5, test light 22 advances straight ahead in the approximately horizontal direction and is introduced into light guide portion 41 through light incident surface 41a. Then, test light 22 propagates through the inside of light guide portion 41, and reaches light exit surface 41b. On light exit surface 41b, test light 22 is divided into reflected light 22a and transmitted light 22b. Reflected light 22a is reflected upward toward an area above light guide portion 41 by reflection, while transmitted light 22b passes through light exit surface 41b and reaches illuminance sensor 42. A ratio between an amount of reflected light 22a and an amount of transmitted light 22b is determined by adjusting angle A of light exit surface 41b, thus determining an amount of light which reaches illuminance sensor 42.

Illumination light 15 is incident on light incident surface 41a from the direction which makes the angle θ with respect to the horizontal direction, and is introduced into light guide portion 41. Illumination light 15 propagates in light guide portion 41 toward light exit surface 41b while being reflected on side surfaces of light guide portion 41 multiple times, passes through light exit surface 41b and is guided to illuminance sensor 42.

### 1-3. Advantageous Effects and the Like

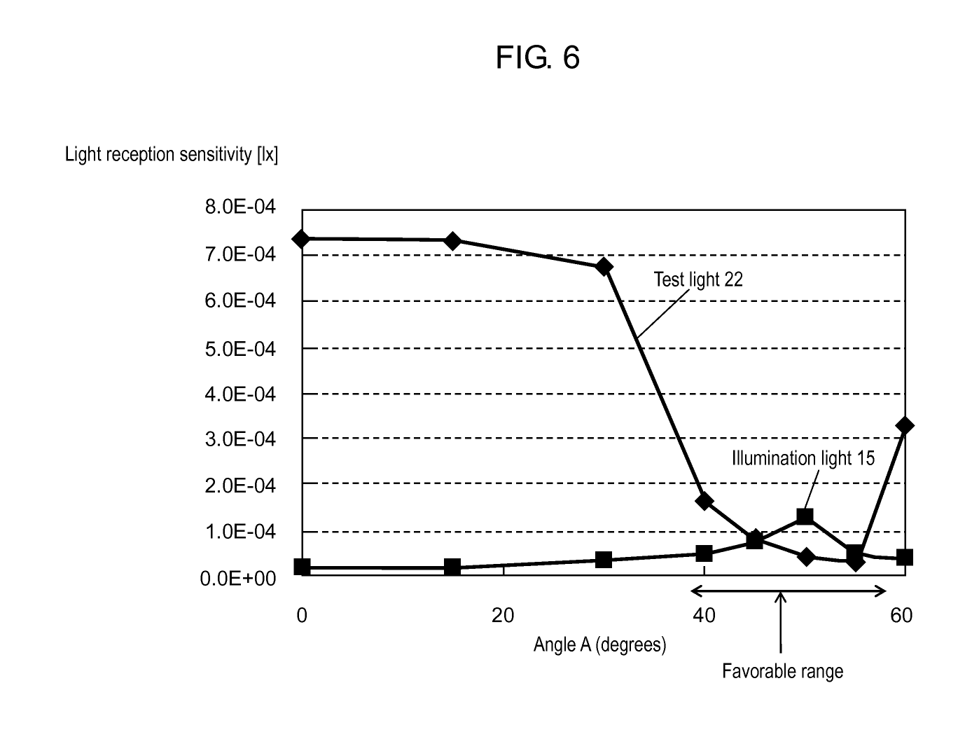

FIG. 6 is a graph showing light reception sensitivity of light receiving portion 42a of light receiving device 16 of this exemplary embodiment. In light receiving device 16, angle A is changed, and light reception sensitivity for illumination light 15 and light reception sensitivity for test light 22 are measured at respective changed angles A. Light reception sensitivity is measured using Lumicept which is light simulation software made by Integra Inc. Light guide portion 41 of light receiving device 16 used for the measurement is formed of a transparent resin member made of polystyrene resin having a thickness of 2 mm, a width of 5 mm, a length of 10 mm and a refractive index of 1.59. Light incident surface 41a of light guide portion 41 is set parallel to a surface of display panel 11. The measurement is performed by setting conditions of test light source as follows. The height of test light source 21 is set equal to the height of light incident surface 41a of light guide portion 41. Test light source 21 is disposed at a position away from light incident surface 41a by approximately 5 feet (1.5 m) in the horizontal direction. Illumination light source 14 is disposed above light incident surface 41a of light guide portion 41 by 2 m and at angle θ which falls within a range from 25° to 70° with respect to the horizontal direction.

In FIG. 6, angle A (degrees) is taken on an axis of abscissas and light reception sensitivity (lx) is taken on an axis of ordinates. Light reception sensitivity of illumination light 15 and light reception sensitivity of test light 22 which are obtained when angle A is changed to 0 degree, 15 degrees, 30 degrees, 40 degrees, 45 degrees, 50 degrees, 55 degrees and 60 degrees are plotted respectively. In FIG. 6, when angle A is 0 degree, 15 degrees and 30 degrees, light reception sensitivity of illumination light 15 differs from light reception sensitivity of test light 22 by 10 times or more. When angle A is set to an angle of approximately 40 degrees which is a total reflection angle of a polystyrene material or larger, a ratio of reflected light 22a of test light 22 which is reflected upward toward an area above light guide portion 41 from light exit surface 41b to transmitted light 22b of test light 22 which passes through light exit surface 41b is increased. Accordingly, an amount of light which reaches illuminance sensor 42 is decreased so that the difference between light reception sensitivity of illumination light 15 and light reception sensitivity of test light 22 is decreased. Further, when angle A is set to 60 degrees, light reception sensitivity of illumination light 15 differs from light reception sensitivity of test light 22 by 10 times or more.

In this exemplary embodiment, assume that the case where the difference between light reception sensitivity of illumination light 15 and light reception sensitivity of test light 22 is 5 times or less becomes the reference for determining whether the brightness adjustment of image display device 100 can be favorably performed in any environment. In this case, a favorable range of angle A is approximately from 38 degrees to 57 degrees. Provided that angle A falls within this range, it is possible to provide light receiving device 16 where brightness adjustment of image display device 100 can be favorably performed by light guide portion 41.

From the above, it is found that angle A is desirably set to an angle equal to or larger than a total reflection angle intrinsic to a material for forming light guide portion 41.

As has been described above, light receiving device 16 of this exemplary embodiment has light incident surface 41a through which light which constitutes illumination light 15 and light which constitutes test light 22 are introduced into light guide portion 41 and light exit surface 41b from which the light which propagates through the inside of light guide portion 41 exits to illuminance sensor 42, and an angle of light exit surface 41b with respect to light incident surface 41a is set to a total reflection angle intrinsic to a material for forming light guide portion 41 or more. Due to such a configuration, test light 22 can be divided into reflected light 22a which is reflected upward toward an area above light guide portion 41 and transmitted light 22b which passes through the light exit surface 41b toward illuminance sensor 42 so that an amount of light which reaches light receiving portion 42a can be decreased. Accordingly, the difference between light reception sensitivity of test light 22 and light reception sensitivity of illumination light 15 can be decreased so that it is possible to provide light receiving device 16 where brightness of image display device 100 can be favorably adjusted by light guide portion 41. That is, the light receiving device according to this disclosure can automatically adjust brightness of a display panel with respect to both external light incident on the light receiving device, that is, external light incident at a predetermined angle with respect to a horizontal direction such as illumination light, and external light incident from an approximately horizontal direction as in the case of test light from a light source for testing products with ABC established by default on “ENERGY STAR (registered trademark) Program” Requirements for Displays.

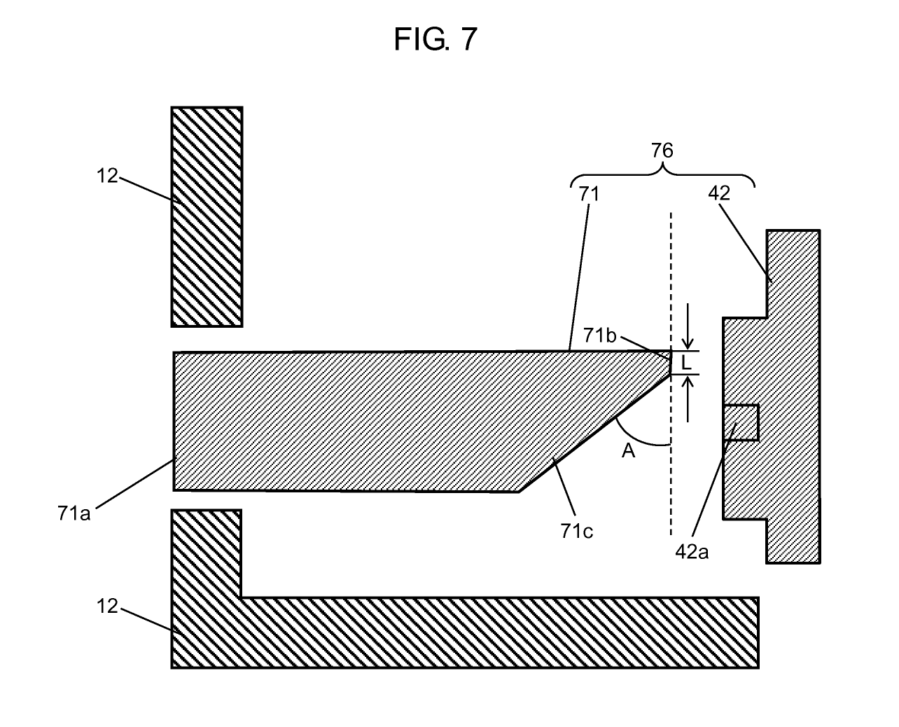

Although the shape of a rear portion of light guide portion 41 of light receiving device 16 shown in FIG. 4 is formed only by light exit surface 41b having a total reflection angle or more, the shape of the rear portion of light guide portion 41 is not limited to such a shape. FIG. 7 is a cross-sectional view of another light receiving device 76 of this exemplary embodiment. As shown in FIG. 7, light receiving device 76 includes light guide portion 71 and illuminance sensor 42. Light guide portion 71 includes light incident surface 71a, flat surface 71b which is parallel to light incident surface 71a, and light exit surface 71c having an angle equal to or more than a total reflection angle. With respect to light guide portion 71, length L of flat surface 71b is adjusted such that light exit surface 71c is disposed in the direction perpendicular to light receiving portion 42a. Therefore, when light receiving portion 42a has a vertical length of 0.4 mm and light guide portion 71 has a thickness of 2 mm, a length of flat surface 71b is set to 0.8 mm or less.

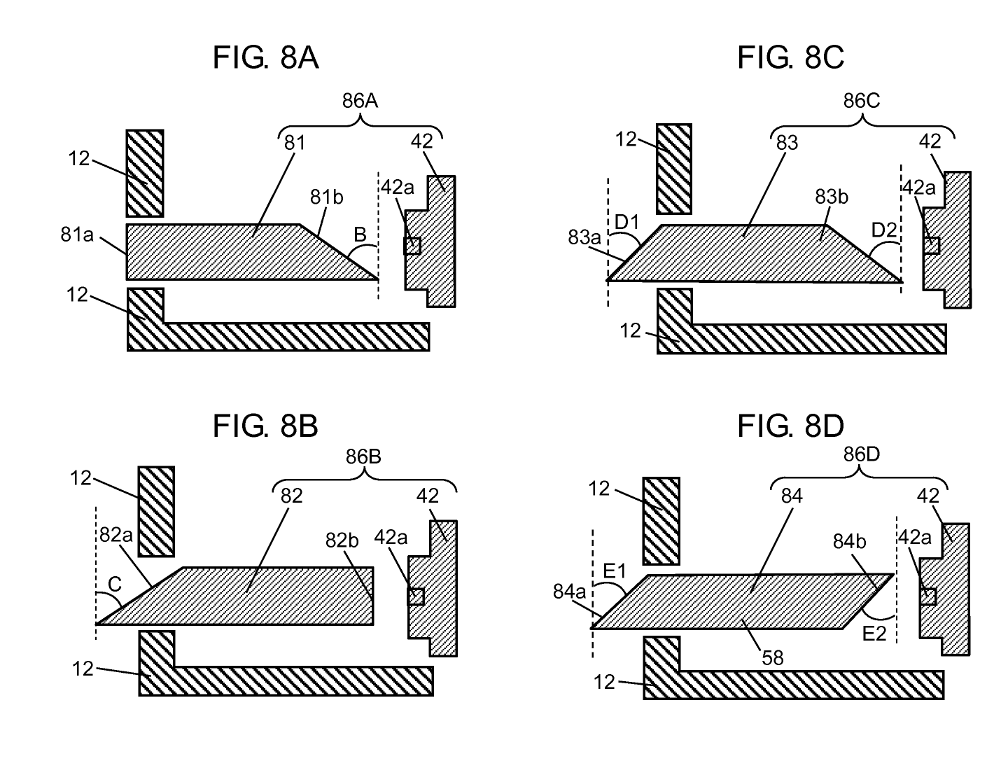

Further, FIG. 8A is a cross-sectional view of still another light receiving device 86A of this exemplary embodiment, FIG. 8B is a cross-sectional view of yet another light receiving device 86B of this exemplary embodiment, FIG. 8C is a cross-sectional view of yet another light receiving device 86C of this exemplary embodiment, and FIG. 8D is a cross-sectional view of yet another light receiving device 86D of this exemplary embodiment.

Light receiving device 86A includes light guide portion 81 and illuminance sensor 42. Light guide portion 81 is formed of a transparent resin member made of polystyrene resin, and has a columnar shape. Light guide portion 81 includes light incident surface 81a which guides illumination light 15 and test light 22 into light guide portion 81, and light exit surface 81b which is formed so as to face the light incident surface 81a with an inclined surface forming angle B with respect to the light incident surface 81a, and enables illumination light 15 and test light 22 to exit to illuminance sensor 42 while adjusting an amount of illumination light 15 and an amount of test light 22.

Light receiving device 86B includes light guide portion 82 and illuminance sensor 42. Light guide portion 82 is formed of a transparent resin member made of polystyrene resin, and has a columnar shape. Light guide portion 82 includes light incident surface 82a which guides illumination light 15 and test light 22 into light guide portion 82, and light exit surface 82b which enables illumination light 15 and test light 22 to exit to illuminance sensor 42 while adjusting an amount of illumination light 15 and an amount of test light 22. Light incident surface 82a is formed so as to face light exit surface 82b with an inclined surface forming angle C with respect to light exit surface 82b.

Light receiving device 86C includes light guide portion 83 and illuminance sensor 42. Light guide portion 83 is formed of a transparent resin member made of polystyrene resin, and has a columnar shape. Light guide portion 83 includes light incident surface 83a which guides illumination light 15 and test light 22 into light guide portion 83, and light exit surface 83b which enables illumination light 15 and test light 22 to exit to illuminance sensor 42 while adjusting an amount of illumination light 15 and an amount of test light 22. Light incident surface 83a is formed so as to face the light receiving portion 42a with an inclined surface forming angle D1 with respect to light receiving portion 42a, and light exit surface 83b is formed so as to face the light receiving portion 42a with an inclined surface forming angle D2 with respect to light receiving portion 42a.

Light receiving device 86D includes light guide portion 84 and illuminance sensor 42. Light guide portion 84 is formed of a transparent resin member made of polystyrene resin, and has a columnar shape. Light guide portion 84 includes light incident surface 84a which guides illumination light 15 and test light 22, and light exit surface 84b which enables illumination light 15 and test light 22 to exit to illuminance sensor 42 while adjusting an amount of illumination light 15 and an amount of test light 22. Light incident surface 84a is formed so as to face the light receiving portion 42a with an inclined surface forming angle E1 with respect to light receiving portion 42a, and light exit surface 84b is formed so as to face the light receiving portion 42a with an inclined surface forming angle E2 with respect to light receiving portion 42a.

In this manner, the difference between light reception sensitivity of light receiving portion 42a for illumination light 15 and light reception sensitivity of light receiving portion 42a for test light 22 may be decreased by providing the inclined surface having an angle B, C, D1, D2, E1, or E2 with respect to a vertical plane to at least one of a light incident surface and the light exit surface.

### Second Exemplary Embodiment

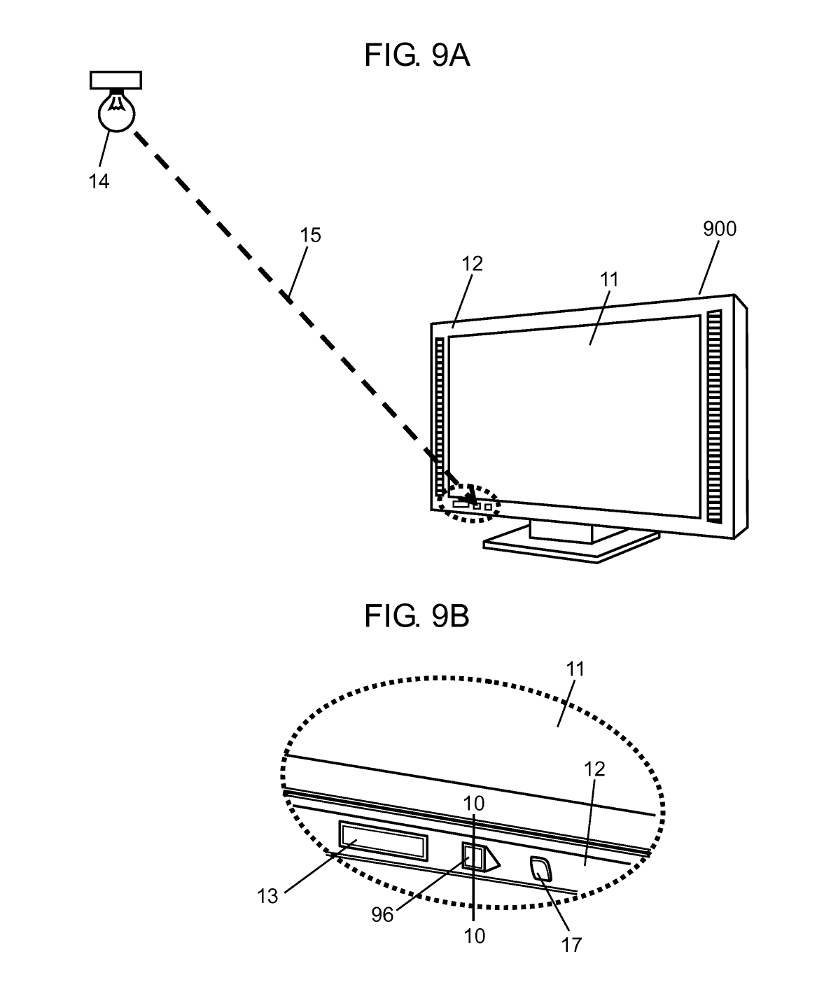

Next, a second exemplary embodiment is described with reference to FIG. 9A to FIG. 13.

### 2-1. Configuration

FIG. 9A is a perspective view showing image display device 900 including light receiving device 96 of the second exemplary embodiment, and FIG. 9B is an enlarged view showing a portion of the image display device surrounded by a dotted line in FIG. 9A in an enlarged manner.

In FIG. 9A and FIG. 9B, flat-plate-shaped image display device 900 includes narrow picture-frame-shaped bezel 12 mounted on the periphery of display panel 11. Three opening portions are formed on a lower side portion of bezel 12, and remote control receiver 13, light receiving device 96 and power source lamp 17 are disposed in the opening portions respectively. Remote control receiver 13 receives remote control signals such as infrared signals from a remote controller (not shown) which is operated by a user. Light receiving device 96 takes in illumination light 15 from illumination light source 14 disposed on a ceiling of a room where image display device 900 is disposed, and automatically adjusts brightness of display panel 11 corresponding to illumination light 15. Power source lamp 17 displays a state of a power source of image display device 100.

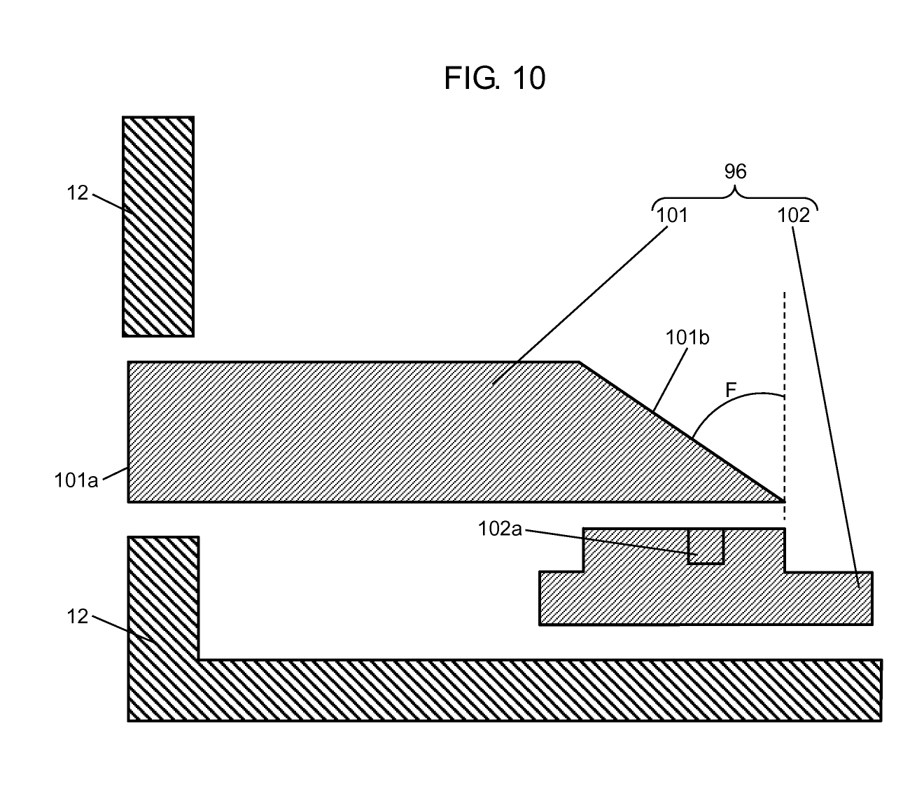

FIG. 10 is a cross-sectional view of light receiving device 96 of the second exemplary embodiment taken along line 10-10 in FIG. 9B. Light receiving device 96 includes light guide portion 101 and illuminance sensor 102. Light receiving device 96 is of a 90-degree bending type where illuminance sensor 102 is bent by 90 degrees with respect to light guide portion 101.

Light guide portion 101 is formed of a transparent resin member made of polystyrene resin, and has a columnar shape. Light guide portion 101 includes light incident surface 101a which guides illumination light 15 and test light 22, and light exit surface 101b which is formed so as to face light incident surface 101a in an inclined manner with respect to light incident surface 101a, and enables illumination light 15 and test light 22 to exit to illuminance sensor 102 while adjusting an amount of illumination light 15 and an amount of test light 22. Illuminance sensor 102 includes light receiving portion 102a which detects illuminance of illumination light 15 and illuminance of test light 22. Here, light receiving portion 102a has a lateral length of 0.4 mm, and light guide portion 101 has a thickness of 2 mm, a width of 5 mm, and a length of 15 mm.

Light exit surface 101b makes predetermined inclination angle F with respect to light incident surface 101a.

### 2-2. Operation

The operation of light receiving device 96 having the above-mentioned configuration is described hereinafter.

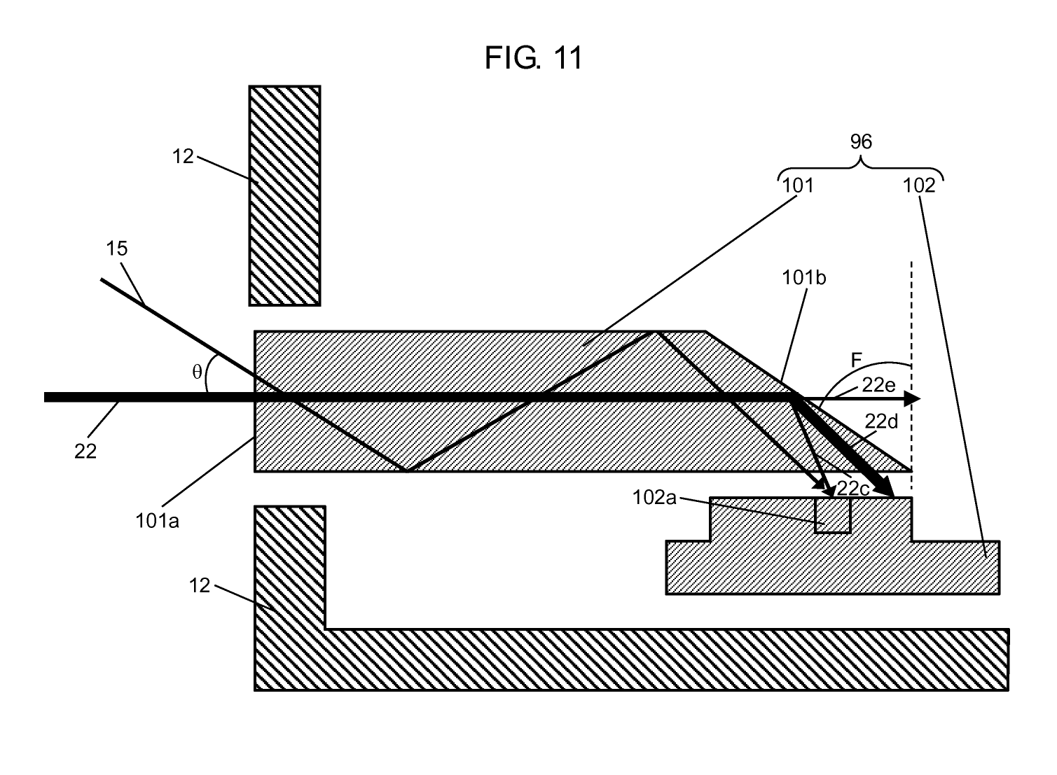

FIG. 11 is a schematic view showing the propagation of test light 22 and illumination light 15 in the cross-sectional view of light receiving device 96 shown in FIG. 10 taken along line 10-10 in FIG. 9B.

As shown in FIG. 11, test light 22 advances straight ahead in the approximately horizontal direction and is introduced into light guide portion 101 through light incident surface 101a. Then, test light 22 propagates through the inside of light guide portion 101, and reaches light exit surface 101b. On light exit surface 101b, test light 22 is divided into reflected light 22c, reflected light 22d and transmitted light 22e. Reflected light 22c is reflected downward toward an area below light guide portion 101 by reflection and reaches light receiving portion 102a of illuminance sensor 102, reflected light 22d is reflected downward toward an area below light guide portion 101 by reflection but does not reach light receiving portion 102a of illuminance sensor 102, and transmitted light 22e passes through light exit surface 101b. A ratio among an amount of reflected light 22c, an amount of reflected light 22d and an amount of transmitted light 22e is determined by adjusting angle F of light exit surface 101b, thus determining an amount of light which reaches illuminance sensor 102.

Illumination light 15 is incident on light incident surface 101a from the direction which makes the angle θ with respect to the horizontal direction, and is introduced into light guide portion 101. Illumination light 15 is guided to illuminance sensor 102 while being reflected on side surfaces of light guide portion 101 multiple times.

### 2-3. Advantageous Effect and the Like

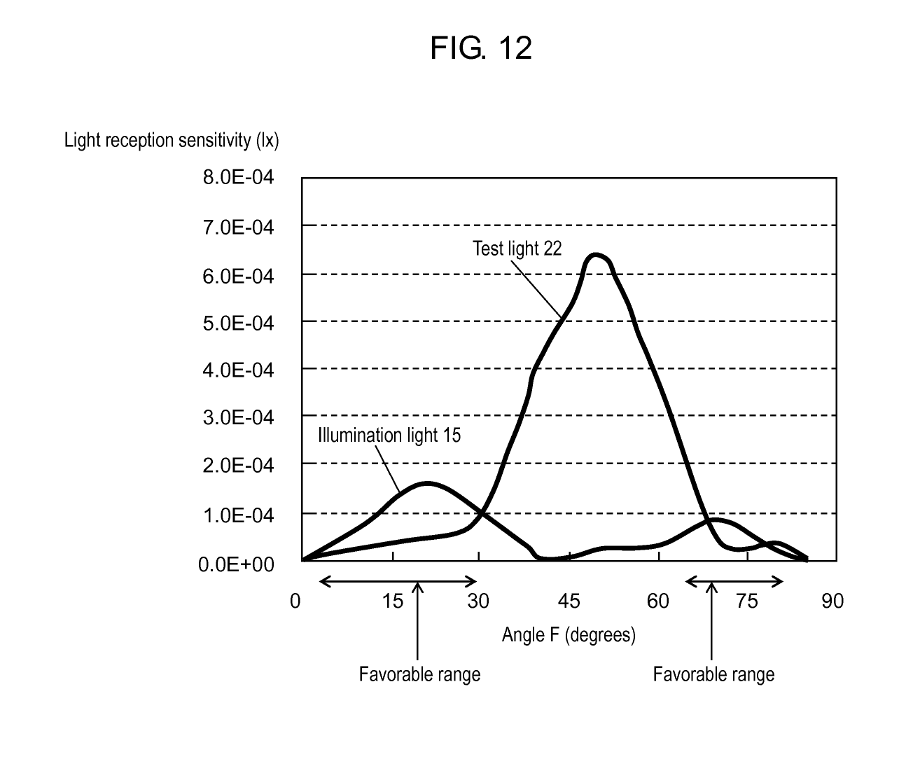

FIG. 12 is a graph showing light reception sensitivity of light receiving portion 102a of light receiving device 96 of this exemplary embodiment. In light receiving device 96, angle F is changed, and light reception sensitivity for illumination light 15 and light reception sensitivity for test light 22 are measured at respective changed angles F. Light reception sensitivity is measured using Lumicept which is light simulation software made by Integra Inc. Light guide portion 101 of light receiving device 96 used for the measurement is formed of a transparent resin member made of polystyrene resin having a thickness of 2 mm, a width of 5 mm and a length of 15 mm. Light incident surface 101a of light guide portion 101 is set parallel to a surface of display panel 11. The measurement is performed by setting under the same conditions of first exemplary embodiment described with reference to FIG. 6.

In FIG. 12, angle F (degrees) is taken on an axis of abscissas and light reception sensitivity (lx) is taken on an axis of ordinates, and light reception sensitivity for illumination light 15 and light reception sensitivity for test light 22 when angle F is changed from 0 degree to 85 degrees are shown respectively. In FIG. 12, when angle F is small, that is, when angle F falls within a range from 0 degree to 30 degrees, with respect to light reception sensitivity for test light 22, an incident angle of light on light exit surface 101b becomes equal to or lower than an angle of approximately 40 degrees which is a total reflection angle of a polystyrene material and hence, a ratio of amount of light which passes through light exit surface 101b and advances behind light guide portion 101 is increased whereby an amount of light which reaches illuminance sensor 102 is decreased. Accordingly, the difference between light reception sensitivity of test light 22 and light reception sensitivity of illumination light 15 is decreased. When angle F falls within a range from 30 degrees to 70 degrees, with respect to light reception sensitivity of test light 22, a ratio of amount of light reflected toward illuminance sensor 102 after being reflected on light exit surface 101b is increased. Particularly, the ratio of light reflected to illuminance sensor 102 becomes conspicuous when an incident angle of light on light exit surface 101b becomes equal to or more than a total reflection angle. Further, when angle F becomes large, that is, angle F falls within a range from 70 degrees to 85 degrees, with respect to light reception sensitivity of test light 22, a ratio of amount of light reflected toward an area behind illuminance sensor 102 after being reflected on light exit surface 101b is increased. Accordingly, an amount of light which reaches illuminance sensor 102 is decreased and hence, the difference between light reception sensitivity for illumination light 15 and light reception sensitivity for test light 22 is decreased.

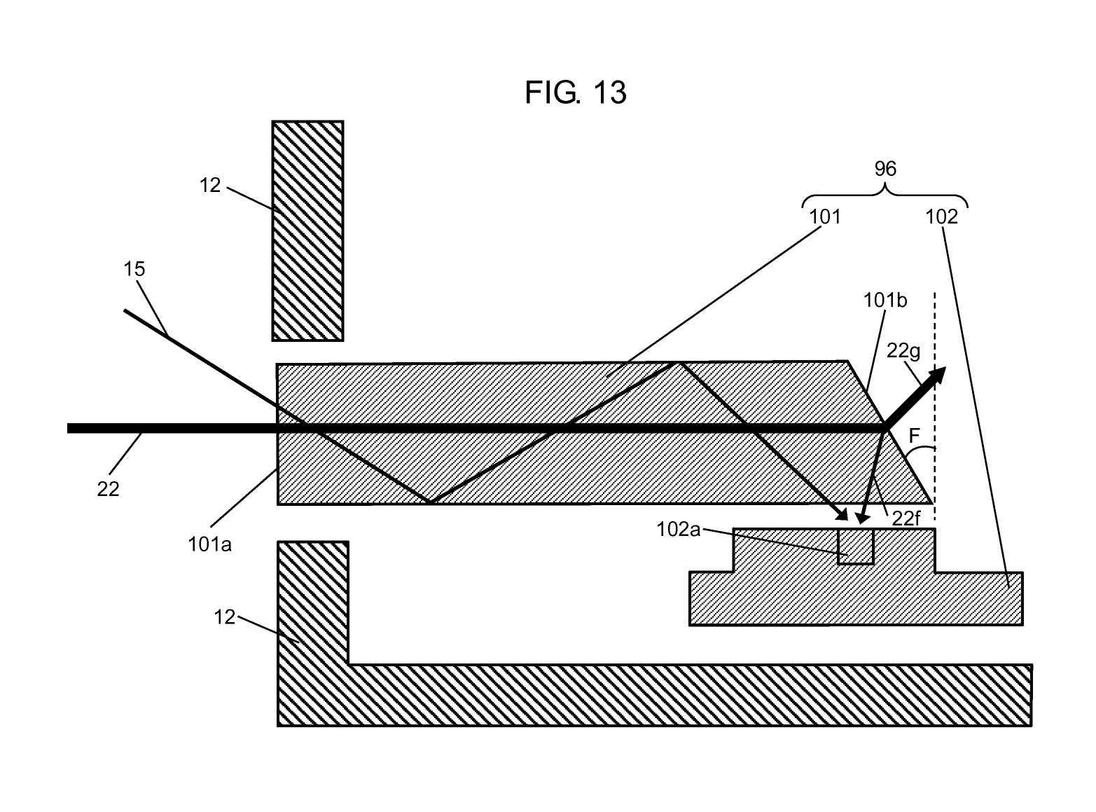

FIG. 13 is a schematic view showing the propagation of test light 22 and illumination light 15 in the cross-sectional view of light receiving device 96 shown in FIG. 10 taken along line 10-10 in FIG. 9B. FIG. 11 shows a case where angle F is set to an angle which falls within a range from 70 degrees to 85 degrees, and FIG. 13 shows a case where angle F is set to an angle which falls within a range from 0 degree to 30 degrees.

As shown in FIG. 13, test light 22 advances straight ahead in the approximately horizontal direction and is introduced into light guide portion 101 through light incident surface 101a. Then, test light 22 propagates through the inside of light guide portion 101, and reaches light exit surface 101b. On light exit surface 101b, test light 22 is divided into reflected light 22f and transmitted light 22g. Reflected light 22f is reflected downward toward an area below light guide portion 101 by reflection and reaches light receiving portion 102a of illuminance sensor 102. Transmitted light 22g passes through light exit surface 101b. A ratio between an amount of reflected light 22f and an amount of transmitted light 22g is determined by adjusting angle F of light exit surface 101b, thus determining an amount of light which reaches illuminance sensor 102.

Illumination light 15 is incident on light incident surface 101a from the direction which makes the angle θ with respect to the horizontal direction, and is introduced into light guide portion 101. Illumination light 15 is guided to illuminance sensor 102 while being reflected on side surfaces of light guide portion 101 multiple times.

In this exemplary embodiment, assume that the case where the difference between light reception sensitivity of illumination light 15 and light reception sensitivity of test light 22 is 5 times or less becomes the reference for determining whether the brightness adjustment of image display device 900 can be favorably performed in any environment. In this case, a favorable range of angle F is approximately from 5 degrees to 30 degrees and 65 degrees to 80 degrees. Provided that angle F falls within this range, it is possible to provide light receiving device 96 where brightness adjustment of image display device 900 can be favorably performed by light guide portion 101.

As has been described above, light receiving device 96 of this exemplary embodiment has light incident surface 101a through which light which constitutes illumination light 15 and light which constitute test light 22 are introduced into light guide portion 101 and light exit surface 101b from which the light which propagates through the inside of light guide portion 101 exits to illuminance sensor 102, and an angle of light exit surface 101b with respect to light incident surface 101a is set to 5 degrees to 30 degrees or 65 degrees to 80 degrees. Due to such a configuration, it is possible to provide light receiving device 96 where brightness of image display device 900 can be favorably adjusted. That is, the light receiving device according to this disclosure can automatically adjust brightness of a display panel with respect to both external light incident on the light receiving device, that is, external light incident at a predetermined angle with respect to a horizontal direction such as illumination light, and external light incident from an approximately horizontal direction as in the case of test light from a light source for testing products with ABC established by default on “ENERGY STAR (registered trademark) Program” Requirements for Displays.

Although a shape of a rear portion of light guide portion 101 of light receiving device 96 shown in FIG. 10 is formed only using light exit surface 101b in the second exemplary embodiment, the shape of the rear portion of light guide portion 101 is not limited to such a shape. For example, light guide portion 101 may be formed using light guide portion 71 described with reference to FIG. 7.

Although a polystyrene material is used as a material for forming the light guide portion in the first exemplary embodiment and the second exemplary embodiment, polycarbonate or acryl may be used. In this case, an angle of the light exit surface may be set by taking into account a refractive index and a total reflection angle intrinsic to a material such as polycarbonate or acryl or the like.

In the first exemplary embodiment and the second exemplary embodiment, the description has been made assuming that illumination light is illumination light from the illumination light source disposed on a ceiling of a room where the image display device is disposed. However, the illumination light is not limited to such illumination light from the illumination light source. The illumination light may be illumination light from an illumination light source disposed on a wall surface of a room where the image display device is disposed, or illumination light from an illumination light source disposed on a floor or a table. Further, the illumination light may be illumination light from a plurality of illumination light sources. In such illumination light, angle θ from a horizontal plane may preferably fall within a range of +20° or more or −20° or less.

What is claimed is:

1. A light receiving device comprising:
an illuminance sensor which detects illuminance of external light; and
a light guide portion which guides the external light into the illuminance sensor,
wherein
the light guide portion has:
a light incident surface through which the external light is introduced into the light guide portion; and
a light exit surface from which the external light introduced into the light guide portion through the light incident surface exits to the illuminance sensor,
at least one of the light incident surface and the light exit surface has an inclined surface,
the external light introduced into the light guide portion through the light incident surface contains external light incident on the light incident surface from a predetermined angle direction and external light incident on the light incident surface from a horizontal direction, and
an angle of the inclined surface is set such that a difference between light reception sensitivity of the illuminance sensor to the external light incident from the predetermined angle direction and light reception sensitivity of the illuminance sensor to the external light incident from the horizontal direction falls within a predetermined range.

2. The light receiving device according to claim 1, wherein
the external light incident from the horizontal direction is test light from a light source for testing products with automatic brightness control (ABC) established by default on “ENERGY STAR (registered trademark) Program” Requirements for Displays.

3. The light receiving device according to claim 1, wherein
a light receiving surface of the illuminance sensor is disposed parallel to a vertical plane, and
the light exit surface includes the inclined surface.

4. The light receiving device according to claim 1, wherein
a light receiving surface of the illuminance sensor is disposed vertically to avertical plane, and
the light exit surface includes the inclined surface.

5. An image display device comprising:
the light receiving device according to claim 1; and
a display panel having a screen on which an image is displayed,
wherein the light receiving device adjusts brightness of the display panel.
